(19) United States
(12) Patent Application Publication
(10) Pub. No.: US 2007/0109265 A1
(43) Pub. Date: May 17, 2007

(54) Mouse with a multi-function button

(75) Inventors: Tzu-Chiang Shih, Taipei (TW); Chih-Hung Lin, Taipei (TW)

Correspondence Address: MADSON & AUSTIN;GATEWAY TOWER WEST, SUITE 900, 15 WEST SOUTH TEMPLE, SALT LAKE CITY, UT, 84101, US

(73) Assignee: Primax Electronics Ltd.

(21) Appl. No.: 11/302,711

(22) Filed: Dec. 14, 2005

(30) Foreign Application Priority Data
Nov. 11, 2005 (TW) 094139556

(51) Int. Cl. G09G 5/08

(52) U.S. Cl. 345/163

(57) ABSTRACT

A mouse with a multi-function button is provided. By using firmware, the scroll wheel signal and the button signal are simulated as the fourth button's information and the fifth button's information of a five-button mouse identifiable by the operation system. Consequently, no additional mouse driver for executing the functions of the fourth and fifth buttons is required when a three-button mouse is used.

### FIELD OF THE INVENTION

The present invention relates to a mouse with multi-function buttons, and more particularly to a mouse capable of simulating scroll wheel signals and button signals as the fourth button's information and the fifth button's information of a five-button mouse identifiable by the operation system of a computer.

### BACKGROUND OF THE INVENTION

Mice have been widely used as input devices in computer systems. By using a mouse, a cursor is moved to a command option on a screen in order to control processing operations of the computer system. As known, the frequently used commands are associated with the scroll up/down functions and the previous page/next page functions upon browsing web pages. At the earliest, the process of operating the mouse is not convenient because the cursor should be moved to the command icon shown on the screen when a user is intended to execute a command. For increasing convenience, several function buttons are added on the mouse and the functions of these function buttons are defined according to the mouse drivers. An example of the mouse having the additional function buttons is a three dimensional (3D) wheel mouse.

The 3D wheel mouse has a scroll wheel. By rotating the scroll wheel in either a forward direction or a backward direction, the image displayed on the computer screen would be scrolled upwards or downwards.

Another mouse having multi-function buttons is a five-button mouse available from Microsoft Corporation under the trademark IntelliMouse, for example. In comparison with the conventional 3D wheel mouse, the five-button mouse has two additional function buttons, i.e. the fourth and fifth buttons. For example, Microsoft Windows2000 operation system and Microsoft WindowsXP operation system defines the fourth and fifth buttons as the commands associated with the “previous page” function and the “next page” function, respectively. When the user presses down the fourth button, the operation system may execute the “previous page” command. Whereas, the “next page” command is executed when the fifth button is pressed down. In other words, the previous page/next page commands are executed without moving the cursor to the command option on the screen.

When compared with the three-button mouse, the five-button mouse has a higher cost. In addition, if another five-button mouse other than that available from Microsoft Corporation, is used, a specified mouse driver should be installed in the computer system and then the functions of the fourth and fifth buttons are set by software.

As previously described, the five-button mouse is not cost-effective. In addition, the five-button mouse is not user-friendly on account of installing the specified mouse driver and setting the functions of fourth and fifth buttons.

In views of the above-described disadvantages resulted from the prior art, the applicant keeps on carving unflaggingly to develop a mouse with multi-function buttons according to the present invention through wholehearted experience and research.

### SUMMARY OF THE INVENTION

It is an object of the present invention to provide a mouse with a multi-function button, in which the scroll wheel signal and the button signal are simulated as the fourth button's information and the fifth button's information of a five-button mouse identifiable by the operation system by using firmware, so that no additional mouse driver for executing the functions of the fourth and fifth buttons is required when a three-button mouse is used.

In accordance with an aspect of the present invention, there is provided a mouse with a multi-function button. The mouse is communicable with an operating system of a computer and comprises a case, a switch, a scroll wheel and a button signal simulation module. The switch is disposed within the case and triggered to generate a button signal. The scroll wheel is disposed within the case and partially protruded from a surface of the case. A forward rotation signal and a backward rotation signal are generated when the scroll wheel is rotated in a forward direction and a backward direction, respectively. The button signal is generated when the scroll wheel is pressed down to trigger the switch. The button signal simulation module is disposed within the case for converting the forward/backward rotation signal and the button signal generated when the scroll wheel is pressed down and rotated in the forward/backward direction into a fourth button's information or a fifth button's information of a five-button mouse identifiable by the operation system.

In an embodiment, the button signal simulation module is implemented by firmware.

In an embodiment, the operation system executes a “previous page” command on a web browser in response to the fourth button's information, and executes a “next page” command in response to the fifth button's information.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic diagram of a computer system for operating a mouse according to a preferred embodiment of the present invention.

### DETAILED DESCRIPTION OF THE PREFERRED EMBODIMENT

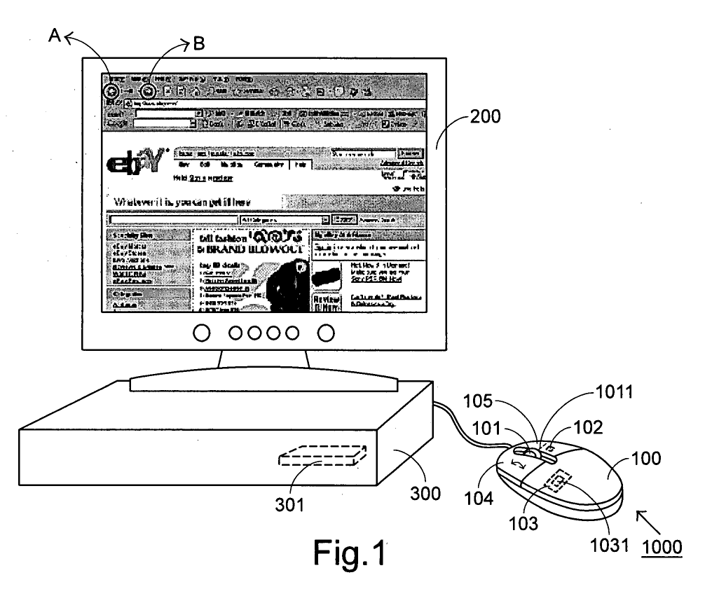

Referring to FIG. 1, a computer system for operating a mouse according to a preferred embodiment of the present invention.

The computer system of FIG. 1 comprises a mouse 1000, a display screen 200 and a host computer 300. The mouse 1000 is communicated with host computer 300 for controlling the image shown on the display screen 200. A web page is shown on the display screen 200. The areas A and B in the line of command icons of the web page indicate the icons “previous page” and “next page”, respectively.

The host computer 300 has been stored therein an operation system 301 such as Microsoft Windows2000 operation system or Microsoft WindowsXP operation system.

The mouse 1000 comprises a case 100, a scroll wheel 101, a switch 102, a control circuit 103, a first button 104 and a second button 105. The first button 104 and the second button 105 are actuated to execute the same functions as the left and right buttons of the conventional mouse. The scroll wheel 101 is rotatable in either a forward direction or a backward direction and can be pressed down. When the user presses down the scroll wheel 101, the rotational axis 1011 of the scroll wheel 101 will trigger the switch 102, which is also referred as the third button of the mouse. The control circuit 103 includes a button signal simulation module 1031 for simulating a scroll wheel signal generated from the scroll wheel 101 and a button signal generated from the switch 102 as a fourth button's information and a fifth button's information of a five-button mouse identifiable by the operation system 301.

The data report format of the Microsoft's five-button mouse is obtainable from the web site http://www.microsoft.com/taiwan/whdc/device/input/mcompat.mspx#EBB.

When the scroll wheel 101 is depressed to trigger the switch 102 and the scroll wheel 101 is rotated in the forward direction, the resulting button signal and the scroll wheel signal are converted by the button signal simulation module 1031 into the fourth button's information identifiable by the operation system 301. In response to the fourth button's information, the operation system 301 executes the command associated with the previous page function A, thereby returning the image to the previous page. Similarly, when the scroll wheel 101 is depressed to trigger the switch 102 and the scroll wheel 101 is rotated in the backward direction, the resulting signals will be converted by the button signal simulation module 1031 into the fifth button's information identifiable by the operation system 301. In response to the fifth button's information, the operation system 301 executes the command associated with the next page function B, thereby shifting the image to the next page.

The tasks performed by the button signal simulation module 1031 will be described as follows.

Firstly, in the step (a), the button signal and the scroll wheel signal are received. Then, according to the scroll wheel signal, the button signal simulation module 1031 will discriminate whether the scroll wheel is rotated in the forward direction or the backward direction (step (b)). Afterward, in the step (c), the fourth button's information conforming to the fourth button signal format of the operation system is transmitted to the host computer when the scroll wheel signal indicates a forward direction, and the fifth button's information conforming to the fifth button signal format of the operation system is transmitted to the host computer when the scroll wheel signal indicates a backward direction.

Moreover the button signal simulation module 1031 is implemented by firmware provided in the control circuit 103. Therefore, it is not necessary to install additional mouse driver for executing the functions of the fourth and fifth buttons.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A mouse with a multi-function button, said mouse being communicable with an operating system of a computer and comprising:
a case;
a switch disposed within said case and triggered to generate a button signal;
a scroll wheel disposed within said case and partially protruded from a surface of said case, wherein a forward rotation signal and a backward rotation signal are generated when said scroll wheel is rotated in a forward direction and a backward direction, respectively, and said button signal is generated when said scroll wheel is pressed down to trigger said switch; and
a button signal simulation module disposed within said case for converting said forward/backward rotation signal and said button signal generated when said scroll wheel is pressed down and rotated in said forward/backward direction into a fourth button's information or a fifth button's information of a five-button mouse identifiable by said operation system.

2. The mouse with a multi-function button according to claim 1 wherein said button signal simulation module is implemented by firmware.

3. The mouse with a multi-function button mouse according to claim 1 wherein said operation system executes a “previous page” command on a web browser in response to said fourth button's information, and executes a “next page” command in response to said fifth button's information.
